(19) United States
(12) Patent Application Publication
(10) Pub. No.: US 2006/0137810 A1
(43) Pub. Date: Jun. 29, 2006

(54) Method of making an elastic laminate using direct contact thermal rolls for controlling web contraction

(76) Inventors: Scott A. Beck, Brookfield, WI (US); Gregory L. Hargrove, Bellefonte, PA (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/023,813

(22) Filed: Dec. 28, 2004

(51) Int. Cl. B32B 37/00; B32B 38/00

(52) U.S. Cl. 156/229; 156/164; 156/282

(57) ABSTRACT

A method of making an elastic laminate includes the steps of feeding a first substrate in a machine direction, feeding a second substrate aligned with the first substrate in the machine direction, and feeding an array of elastomeric strand material stretched in the machine direction between the first and second substrates. A hot melt adhesive is applied onto the strand material, and a curable adhesive is applied to one or both of the substrates. The two substrates and the elastomeric strand material are then compressed to form an elastomeric preform web while maintaining the elastomeric strand material in its stretched state. The stretched elastomeric preform web is then heated in line by feeding it over heated rolls, and thereafter allowed to relax and contract in the machine direction as it cools and moves downstream from the heated rolls to form a gathered elastomeric laminate. A release liner is fed in the machine direction and aligned with the gathered elastomeric laminate, and a pressure sensitive adhesive is applied to the release liner. The gathered elastomeric laminate and release liner are then compressed to form the elastic laminate which is particularly useful as window flashing.

### FIELD OF THE INVENTION

This invention relates to a method of fabricating laminated elastic webs that are useful as elasticized structures, and more specifically, useful in outdoor applications such as window flashing.

### BACKGROUND OF THE INVENTION

Many disposable or non-disposable articles have laminated elastic components forming one or more expandable or stretchable portions in the article. For example, some of these types of articles include sweatbands, bandages, and elastic waistbands, side panels and leg cuffs in disposable diapers. The laminated elastic components of disposable diapers may be comprised of two layers of nonwoven fabric having elastomeric strands adhered therebetween. The elastomeric strands are laminated to the nonwoven layers in a pre-stretched condition. When the elastomeric strands relax, the nonwoven material gathers. The machines and tooling required for integral fabrication of laminated elastic articles are extremely complex.

Typically, the elastomeric strands and substrates are joined together by adhesives, such as hot melt pressure sensitive adhesives. Hot melt adhesives typically exist as a solid mass at ambient temperature and can be converted to flowable liquid state by the application of heat. In these applications, the hot melt adhesive is heated to its molten state and then applied to a substrate. A second substrate is then immediately laminated to the first and the adhesive solidifies on cooling to form a strong bond. The major advantage of hot melt adhesives is the lack of a liquid carrier, as would be the case for water-based or solvent based adhesives, thereby eliminating the relatively costly drying step necessary to remove the water or solvent. Also, hot melt adhesives can be formulated to have relatively short open times, and thus do not require any curing and/or crosslinking. Thus, hot melt adhesives typically have high “green” strength upon application. Suitable hot melt adhesives must possess the appropriate bond strength to adhere the substrates involved, and must also possess adequate flexibility, staining or bleedthrough resistance, suitable viscosity and open time to function on commercial equipment, acceptable stability under storage conditions, and acceptable thermal stability under normal application temperature.

Many different polymers have been used in hot melt adhesives employed in the construction of laminates. In this regard, typical hot melt adhesives have employed polymers which have included styrene-isoprene-styrene (SIS); styrene-butadiene-styrene (SBS); styrene-ethylene-butylene-styrene (SEBS); ethylene-vinyl acetate (EVA); and amorphous poly-alpha-olefin (APAO). While these polymers, when properly blended, provide acceptable adhesion between most substrates employed in typical disposable goods construction such as diapers or packaging materials, they have several shortcomings which have detracted from their usefulness in connection with outdoor applications such as window flashing.

One of the most noteworthy shortcomings of hot melt adhesives concerns their durability. Typical hot melt adhesives do not perform well under conditions involving large temperature extremes such as outdoor applications where summer and winter temperatures can vary dramatically. Also, the long term aging, i.e. UV stability, of hot melt adhesives is also a concern with outdoor applications which are exposed to sunlight. Thus, it would seem logical to use an adhesive that provides long term strength, is UV stable and can perform well under wide temperature variances to bond a laminate structure together for use in outdoor applications. However, in order to obtain such characteristics, one must look toward curable or crosslinkable adhesives such as polyurethane based adhesives. Unfortunately, due to the need for curing and/or crosslinking, and thus the time involved for curing and/or crosslinking, such adhesives have low “green” strength and would thus have inadequate bonding capabilities upon initial application. As a result, the use of curable or crosslinkable adhesives such as polyurethane in elasticized laminated webs is not practical since the web may partially delaminate after fabrication.

U.S. Pat. No. 6,491,776 discloses a method for making a laminated, gathered, elastic web which utilizes a combination of a hot melt pressure sensitive adhesive and a curable adhesive to overcome the disadvantages of each individual adhesive. In the '776 process, a hot melt pressure sensitive adhesive, such as a styrene-isoprene-styrene (SIS) based adhesive, is applied onto the elastomeric strands, and a curable adhesive, such as a polyurethane based adhesive, is applied to one of the substrates. Thereafter, the two substrates and the elastomeric strands are compressed to form a laminate elastic web while maintaining the elastomeric strands in their stretched state. Machine direction tension is maintained on the laminate until the hot melt adhesive cools and bonds the layers together. Thereafter, the machine direction tension is released to permit the elastic web to contract to form a gathered elastic web. The pressure sensitive hot melt adhesive is a thermoplastic adhesive that provides the green strength necessary to initially bond the laminated elastic web together while the curable adhesive provides long term strength for the structure over a range of temperature extremes, as well as excellent ultraviolet light stability which is desirable for outdoor applications such as window flashing.

In order to be useful as window flashing, the gathered elastic web produced by the process disclosed in U.S. Pat. No. 6,491,776 must be coated on one side with another adhesive, usually a butyl adhesive which in turn is covered with a release liner or film. In order to accomplish this, the laminate is first heated to a temperature between about 200° F. to about 300° F., and it is then allowed to cool so that it will contract in the machine direction. These heating and cooling steps are performed in an attempt to maximize the stretchability of the laminate since heating and subsequent cooling allows the substrates to soften and the elastic strands to contract more completely. After contraction, the butyl adhesive is applied to the release liner and then the release liner with the butyl applied thereon is laminated onto the gathered elastic web. In use, one merely peels off the release liner, stretches the elastic laminate and presses it into position about a window opening.

The process of heating the laminate to contract it in the machine direction is typically performed by feeding the laminate through a hot non-contact oven. Although this type of heating will cause shrinkage or contraction of the laminate, it lacks thermal control so that the amount and direction of shrinkage or contraction is unpredictable. As a result, the laminate may become distorted. For example, the laminate may become “skewed” in the machine direction, i.e. instead of being straight in the machine direction, the laminate may become “S-shaped” with varying degrees of offset in the machine direction. Another problem involves what is referred to as “stove-piping” where the longitudinal edges of the laminate curl upwardly or downwardly so that instead of being planar in shape, the laminate is arcuate-shaped in cross section. Skewing is a result of uneven contraction in the machine direction while stove-piping or curling is the result of uneven contraction in the cross machine direction. If the laminate becomes skewed in the machine direction or curled in the cross machine direction, the laminate cannot be easily rolled and/or boxed in a festooning station for packaging. As a result, it is desirable to provide a manufacturing process that provides thermal control of laminate contraction to eliminate skewing and stove-piping.

### SUMMARY OF THE INVENTION

The present invention provides a method of controlling the dimensional contraction of a heated elastomeric web to form a gathered elastomeric laminate that eliminates undesirable skewing and stove-piping. The method includes the steps of feeding an elastomeric preform web in a machine direction wherein the elastomeric preform web is stretched in the machine direction and then heating the stretched elastomeric preform web by contacting one or both sides thereof with at least one heated roll. Thereafter, the stretched elastomeric preform web is allowed to contract as it cools and moves downstream from the heated roll(s) to form a gathered elastomeric laminate. Preferably, the stretched elastomeric preform web contacts a plurality of sequentially arranged rolls in a serpentine path so that one or both sides thereof are heated to a desired temperature. The uniform heat transfer between the hot outer surfaces of the heated rolls and the outer faces of the stretched elastomeric preform web and the simultaneous stretching of the preform web itself while it is being heated provide the desired thermal control over web contraction. In addition, direct contact with a heated roll is more efficient than heating a laminate in an air convection oven. The gathered elastomeric laminate may then optionally be coated on one side with a pressure sensitive adhesive, such as a butyl adhesive or a pressure sensitive hot melt adhesive, and a release liner may be applied over the adhesive to form an elastic laminate useful as window flashing if desired.

The method advantageously maintains control over web contraction by in line heating performed during the process. In line heating, preferably performed by passing the preform web over heated rolls while the web is stretched, provides uniform heat transfer between the heated rolls and the preform web. This uniform heat transfer, together with the uniform machine direction tensioning of the preform web across its entire width as it moves downstream over the heated rolls results in minimizing or eliminating material curl in the cross machine direction as well as uneven contraction in the machine direction. In line heating using hot rolls also increases machine direction contraction of the final elastic laminate to provide a more versatile final product having a wide range of stretchability.

In another aspect of the invention, there is provided a method of making an elastic laminate. The method includes the steps of feeding a first substrate in a machine direction, feeding a second substrate aligned with the first substrate in the machine direction, and feeding an array of elastomeric strand material between the first and second substrates in such a manner that the elastomeric strand material is stretched in the machine direction and aligned with the first and second substrates. A hot melt pressure sensitive adhesive, such as a styrene-isoprene-styrene based adhesive, is applied onto the elastomeric strand material, and a curable adhesive, such as a polyurethane based adhesive, is applied to one or both of the substrates. The two substrates and the elastomeric strand material are then compressed to form an elastomeric preform web while maintaining the elastomeric strand material in its stretched state. The stretched elastomeric preform web is then heated in line by contacting at least one side thereof with at least one heated roll, and thereafter allowed to relax and contract in the machine direction as it cools and moves downstream from the heated roll(s) to form a gathered elastomeric laminate that has a degree of contraction in the machine direction that is significantly greater than if the preform web had been allowed to contract without heating. A release liner is fed in the machine direction and aligned with the gathered elastomeric laminate, and a pressure sensitive adhesive is applied to either the gathered elastomeric laminate or the release liner. The gathered elastomeric laminate and release liner are then compressed to form the elastic laminate, particularly useful as window flashing.

The pressure sensitive hot melt adhesive applied to the strands is a thermoplastic adhesive that provides the green strength necessary to initially bond the laminated preform web together while the curable adhesive applied to one or both substrates provides long term strength for the structure over a range of temperature extremes, as well as excellent ultraviolet light stability which is desirable for outdoor applications such as window flashing. The pressure sensitive hot melt adhesive thus must have sufficient strength to initially bond the elastic strands in place. One preferred example would be a hot melt adhesive used in bonding elastic strands in disposable articles, such as diapers. The curable adhesive may be any one of a variety of single component or dual component adhesives. The curable adhesive is preferably applied using hot melt application equipment. For example, if a single component system, the adhesive may be heat curable or moisture curable, but is preferably moisture curable polyurethane based. If a two component system, the curable adhesive may also be urethane based or may be epoxy based.

The two substrates are preferably comprised of a spun-bonded high density polyethylene web and a low density polyethylene film. The pressure sensitive hot melt adhesive is applied at an add-on level of from about 2 to about 20 grams per square meter, but preferably about 15 grams per square meter. Likewise, the curable adhesive is applied at an add-on level of about 2 to about 20 grams per square meter, but preferably at a level of about 6 grams per square meter.

The method of the present invention thus overcomes not only the disadvantages of each individual adhesive, but also the disadvantages and quality control problems of the prior art method of heating in a separate hot air convection oven prior to applying a butyl adhesive and a release liner on the final product. Preferably the method provides for making an elastic laminate specifically adapted for outdoor applications, such as window flashing. Various other features, objects and advantages of the invention will be apparent to those skilled in the art upon reviewing the following drawings and description thereof.

### BRIEF DESCRIPTION OF THE DRAWINGS

The drawings illustrate the best mode presently contemplated of carrying out the invention.

In the drawings:

FIG. 1 is a perspective view of an elastic laminate which is useful as window flashing and is made in accordance with the method of the present invention;

FIG. 1A is an end view of the elastic laminate of FIG. 1 illustrating the components thereof in greater detail;

FIG. 2 is a general schematic diagram illustrating the apparatus used in making the elastic laminate shown in FIG. 1 wherein only one side of an elastomeric preform web is heated;

FIG. 2A is a schematic diagram similar to FIG. 2 illustrating a second embodiment wherein both sides of the preform web are heated;

FIG. 2B is a schematic diagram similar to FIGS. 2 and 2A illustrating a third embodiment wherein the process is discontinuous;

FIG. 3 is a top view of an elastomeric preform web made during the process of FIG. 2, illustrating various degrees of stretching of the preform web as the elastic in the laminate relaxes;

FIG. 4 is a partial section view taken along line 4-4 of FIG. 3 illustrating the preform web in a relatively gathered condition;

FIG. 5 is a partial section view taken along line 5-5 of FIG. 3 illustrating the preform web in a stretched condition;

FIG. 6 is a partial section view taken along line 6-6 in FIG. 3 which illustrates and exaggerates the adhesive bond between the two substrate layers and elastic strands extending therethrough; and

FIG. 7 is a partial section view taken along line 7-7 of FIG. 6 further illustrating one elastic strand retained between the two substrate layers.

### DETAILED DESCRIPTION OF THE INVENTION

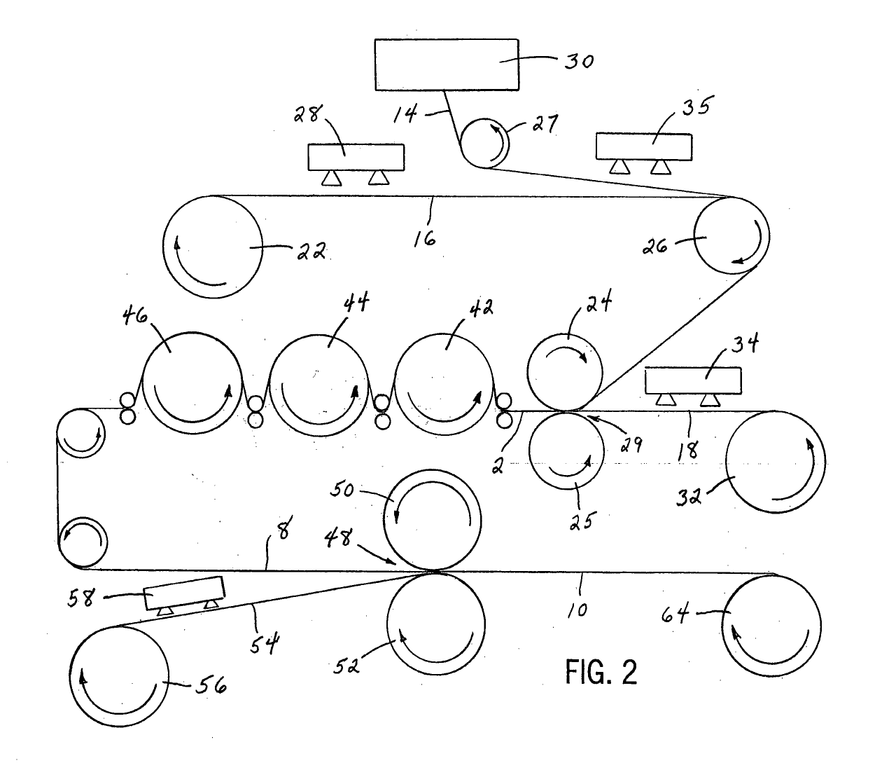

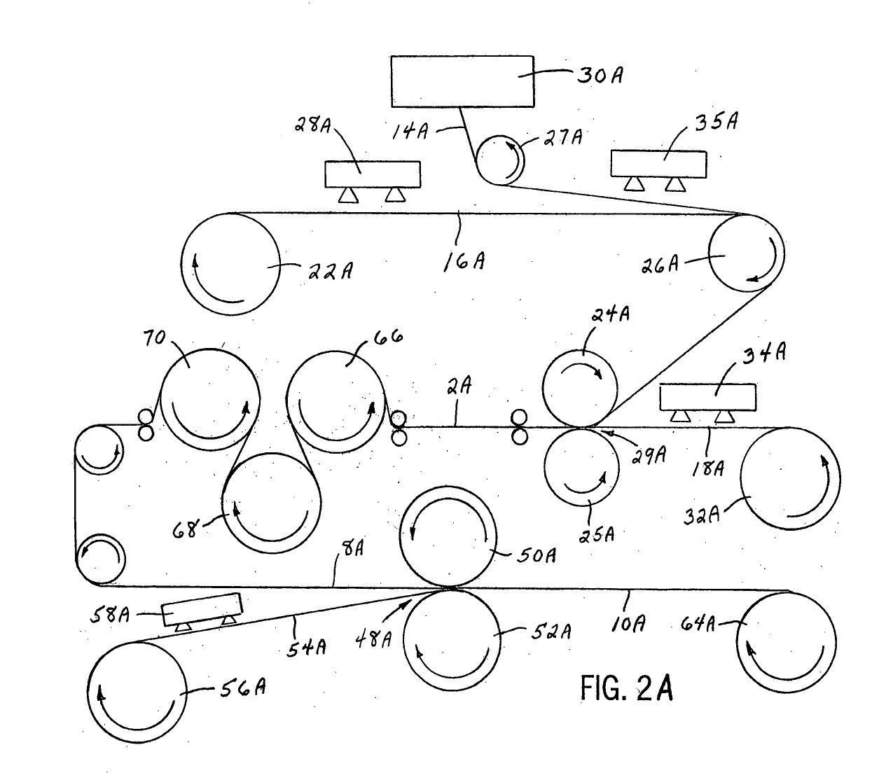

As used herein, the term “elastic laminate” refers to the final product made by the process illustrated in FIG. 2 and/or FIG. 2A and designated by the numeral 10 and/or 10A respectively herein. That final product includes a lamination composed of a gathered elastomeric web (as herein designated by the numeral 8, 8A and/or 8B), a release liner and a pressure sensitive adhesive disposed between the gathered elastomeric laminate and the release liner. The final product may be used in outdoor applications such as window flashing.

As used herein, the term “elastomeric preform web” or “preform web” refers to the initial lamination made by the process illustrated in FIG. 2, FIG. 2A and/or FIG. 2B and designated by the numeral 2, 2A and/or 2B respectively herein. That initial lamination includes one or more substrates, an elastic layer stretched in the machine direction and an adhesive layer that bonds the substrates and stretched elastic layer together, and is the stretched lamination formed prior to releasing machine direction line tension and prior to contraction of the lamination.

As used herein, the term “gathered elastomeric web” or “gathered web” refers to the initial lamination defined above as the “elastomeric preform web” or “preform web,” but is the lamination formed subsequent to releasing machine direction line tension and after contraction of the lamination to a gathered construction and is designated by the numeral 8, 8A and/or 8B herein.

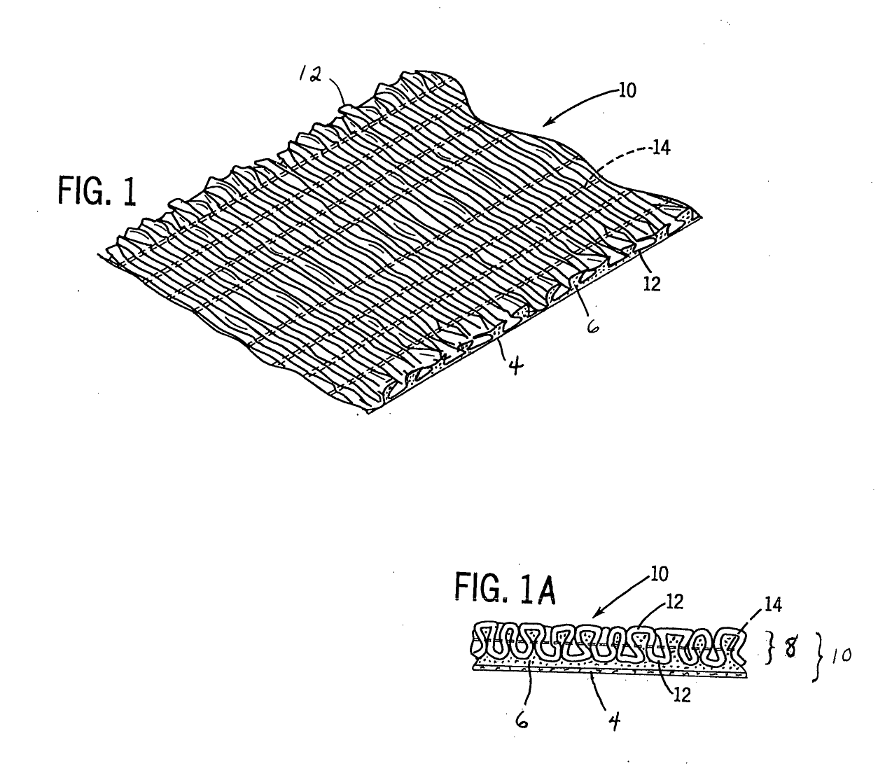

FIG. 1 illustrates a strip of an elastic laminate 10 constructed in accordance with the method and apparatus of the present invention. Although only a portion of the elastic laminate 10 is shown in FIG. 1, it should be understood that the elastic laminate 10 has a continuous length that is later cut to a desired length by the end user. The laminate 10 is advantageously stored and dispensed in roll form. In its preferred embodiment, the elastic laminate 10 is approximately 8 inches wide although the width of the elastic laminate 10 can vary depending on the application. In the preferred embodiment of the invention, the elastic laminate 10 includes an elastic layer comprised of forty-six adjacent individual elastomeric strands 14 extending longitudinally in the machine direction along the continuous length of the laminate 10. It should be understood that a larger or smaller number of elastomeric strands 14 can be used in accordance with the invention, depending upon the particular end use for the elastic laminate 10. In the preferred embodiment, the elastomeric strands 14 are individual strands of Lycra® XA, a segmented polyurethane commercially available from Invista, Inc. It is contemplated that the elastic layer may be comprised of other types of elastic materials that could be substituted for the elastomeric strands 14, such as various elastic films, mesh, scrim, threads or adhesives, as long as they provide the desired elasticity to the laminate 10.

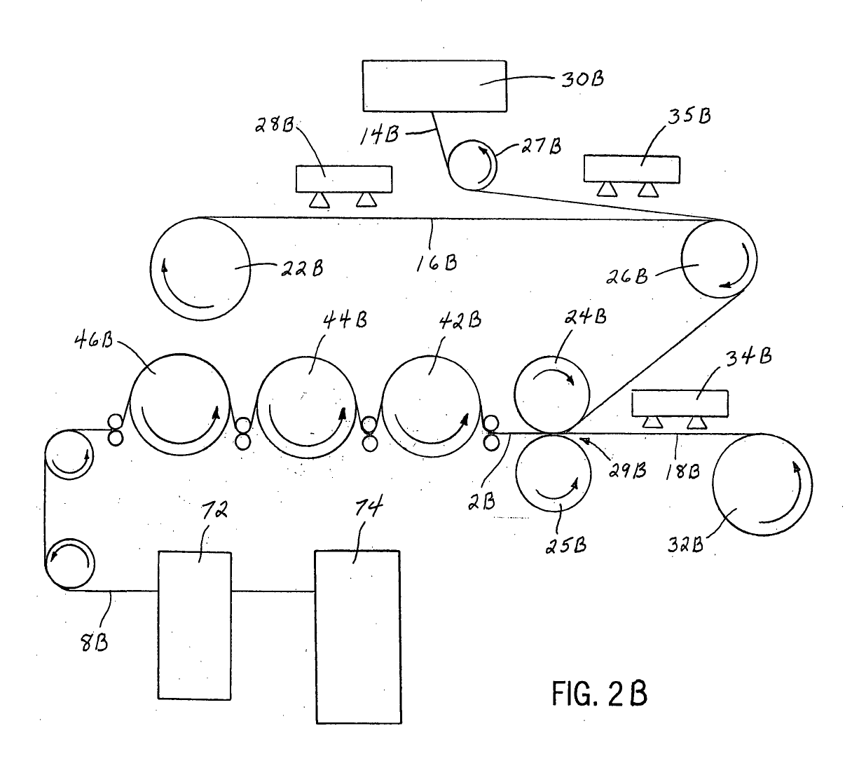

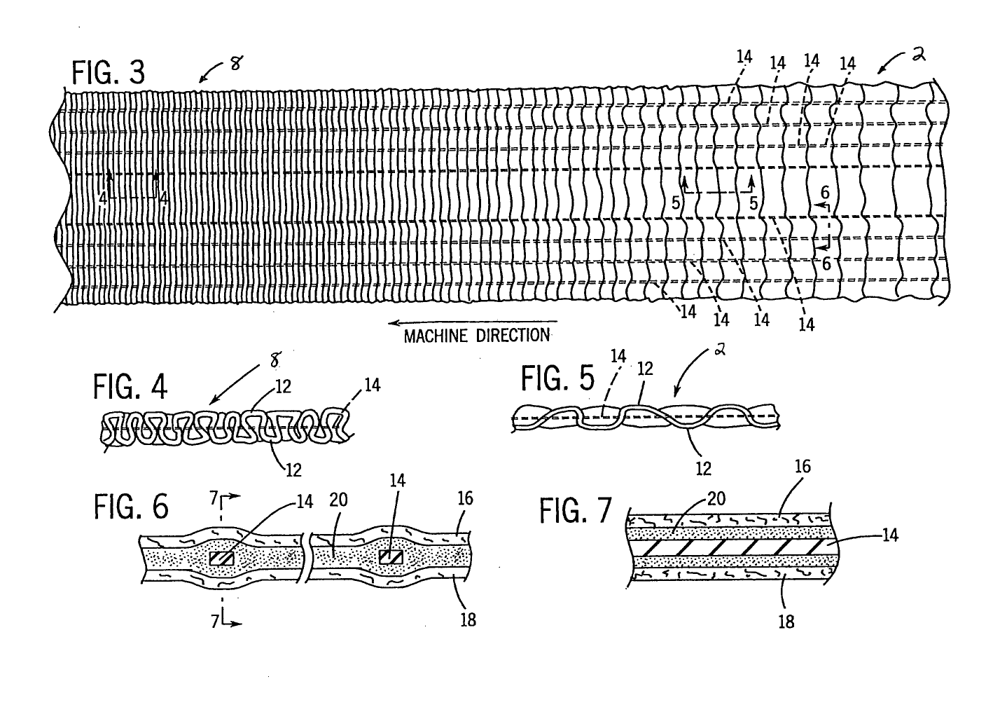

Referring now in particular to FIG. 1A, the elastic laminate 10 preferably includes a gathered elastomeric web 8, a release liner 4 and a pressure sensitive adhesive 6 disposed between web 8 and liner 4. Gathered web 8 is illustrated in FIGS. 3 and 4, and is structurally identical to preform web 2 which is illustrated in FIGS. 5, 6 and 7 in that structures 8 and 2 are both composed of a first substrate or layer 16, a second substrate or layer 18, elastic strands 14, and an adhesive layer 20 which functions to bond substrates 16, 18 and strands 14 together. The difference, however, is that web 2 is not yet contracted (see FIG. 5) while web 8 is contracted (see FIG. 4) in the process illustrated in FIG. 2. It should be pointed out that the invention is not limited to webs and/or laminates having only two substrates. The fabrication technique disclosed herein can be used for elastic laminates, gathered webs and/or elastomeric preform webs having more than two substrates, i.e. multi-layered, or even for a web or laminate having a single substrate, i.e. a monolayer. In the preferred configuration shown in FIG. 6, the first substrate 16 and the second substrate 18 capture and sandwich the elastic strands 14 therebetween. In some cases, the first substrate 16 and the second substrate 18 can be similar types of materials, and in other cases they may be dissimilar types of materials, depending on the desired end use of gathered web 8 and/or elastic laminate 10. As a specific example, the preferred composition of first substrate 16 is a spun-bonded, high density polyethylene web material available from Du Pont under the brand name Tyvek®. The second substrate 18 is preferably a linear low density polyethylene film material available from a number of suppliers, such as Clopay, Inc., but may also be composed of any of numerous other polyolefin films.

Referring to FIGS. 6 and 7, the elastomeric strands 14 are retained between the first substrate 16 and the second substrate 18 by an adhesive layer 20 to form preform web 2. The elastomeric strands 14 are adhered both to the first substrate 16 and the second substrate 18. Suitable adhesives comprising layer 20 have the proper adhesive properties to prevent the elastomeric strands 14 from slipping between the substrates 16 and 18. Additionally, the selected adhesive layer 20 should provide an adequate bond to adhere the first substrate 16 to the second substrate 18. In the preferred embodiment of the invention, the adhesive layer 20 is actually composed of two different adhesives, namely, a pressure-sensitive, hot-melt adhesive, such as a styrene-isoprene-styrene (SIS) based adhesive Product No. H2385, available from Bostik, Inc., the assignee of the present invention, and a curable adhesive, such as an aliphatic moisture cure polyurethane based adhesive Product No. XPU 18228, also available from Bostik, Inc.

The release liner 4 used in elastic laminate 10 may be composed of any sheet or film material that initially adheres to adhesive 6 but may be readily removed or peeled away to expose adhesive 6. Thus, the bond between liner 4 and adhesive 6 must be sufficient to hold liner 4 in place over the adhesive 6 but not so strong that liner 4 cannot be readily peeled away from adhesive 6 or that it results in cohesive failure of adhesive 6 when peeled away or that it results in adhesive failure between adhesive 6 and substrate 18 when peeled away. Release liners are well known in this art, and one type of preferred liner 4 comprises siliconized paper. Liner 4 may also be composed of other materials such as siliconized polypropylene and/or siliconized polyethylene.

Adhesive layer 6 may be composed of any pressure sensitive adhesive such as natural and/or synthetic rubber adhesives. Typical synthetic rubber adhesives include butyl adhesives, a polyisobutylene adhesive, an isobutylene copolymer adhesive, and a styrenic block copolymer based hot melt adhesive. The preferred adhesive for outdoor applications such as window flashing is a butyl adhesive. A butyl adhesive typically is based on and contains a butyl polymer such as butyl, bromobutyl, chlorobutyl, star-branched butyl and star-branched halobutyl. Star-branched butyl polymers (regular butyl and halogenated butyl) are copolymers of isobutylene and isoprene which include a styrene block copolymer branching agent. Butyl adhesives are readily available commercially, such as under the trade designation 1183 from Bostik, Inc. Polyisobutylene adhesives are readily available commercially, such as under the trade designation H9135-01 from Bostik, Inc.

The preform web 2 made by the present process can be manufactured by joining together the first and second substrates 16, 18 and the array of elastomeric strand material 14 using a high speed (e.g. 150-600 feet per minute) lamination machine, as schematically shown in FIG. 2. The term “array” refers to the arrangement or pattern of strands 14 being bonded between substrates 16, 18. In the web 2, strands 14 are fed in the machine direction and are parallel and spaced from one another in a single plane. Those skilled in this art will recognize that different arrays could be used. It is also to be understood that FIG. 2 illustrates the array of strands 14 as a single line only as a matter of convenience, and thus this line in FIG. 2 represents the entire array of strands 14. First substrate 16 is in the form of a thin film or sheet of material and is delivered from supply roll 22 and fed at a predetermined speed towards adhesive applicator 28 and around roll 26 to nip 29 formed between nip rolls 24 and 25. An array of elastomeric strands 14 is aligned in the machine direction and is under machine direction tension in a stretched state, preferably between about 150% to 350% of their relaxed length, and most preferably between about 200%-300% elongation, during the lamination process. The elastomeric strands should be stretched sufficiently to cause gathering of the first and second substrates 16, 18 but not stretched so much that the elastomeric strands 14 break and cause process interruptions.

The array of elastomeric strands 14 is fed to nip 29 from an elastomeric strand unwind station 30. The elastomeric strand unwind station 30 is well known in this art, and includes a plurality of spools (not shown) for dispensing the individual elastomeric strands 14. The elastomeric strands 14 are pulled from the spools located within station 30, and are pre-stretched to at least 150% of their relaxed length. In the preferred embodiment of the invention, the elastomeric strands 14 are pre-stretched to approximately 280% of their relaxed length.

Once pre-stretched, the elastomeric strands 14 are fed around idler roll 27 and then around roll 26 and into nip 29. The laminating machine operates at a line speed, which is about 300 feet/minute, but can be adjusted depending on conditions. The second substrate 18 is also in the form of a thin film or sheet of material and is delivered from supply roll 32, aligned with substrate 16 and strands 14, and fed into the nip 29 of the machine at the same line speed as substrate 16 and strands 14. Preferably, the first and second substrates 16, 18 are sheets of material having a width of approximately 8 inches. After being joined together, substrates 16, 18 may eventually be cut transversely or in a crosswise direction downstream from the laminating machine to form any number of laminated structures each having a desired width and length.

A curable adhesive, such as a moisture curable adhesive, e.g. a moisture curable polyurethane based adhesive, is applied onto substrate 16 using adhesive applicator 28. Optionally, a curable adhesive may also be applied onto substrate 18 using adhesive applicator 34. Examples of suitable applicators are spray and slot coaters, preferably a slot coater.

An adhesive, such as a pressure sensitive hot melt adhesive, is also applied onto strands 14 using adhesive applicator 35. Examples of suitable adhesive applicators are spray and slot coaters. The hot melt adhesive can be held in a molten state in a hot reservoir and pumped therefrom through nozzles or die orifices, respectively, and applied to strands 14. In the embodiment shown in FIG. 2, the adhesive is meltblown or sprayed onto the array of elastomeric strands 14. In a preferred embodiment where the first substrate 16 is a spun-bonded high density polyethylene web and the second substrate 18 is a linear low density polyethylene film, the adhesive is preferably applied to the side of strands 14 that faces the low density polyethylene sheet. Also, it is preferred that the curable adhesive be applied to substrate 16 first, and thereafter followed by application of the hot melt adhesive onto strands 14.

The first substrate 16 and the array of elastomeric strands 14 are brought into contact with second substrate 18, which is delivered from supply roll 32, at nip 29 formed by counter-rotating nip rolls 24 and 25. The first and second substrates 16, 18 are forced (by compression) into direct contact with the stretched elastomeric array of strands 14, the hot melt adhesive and the curable adhesive in the nip 29 to form a tensioned or stretched elastomeric preform web 2 with the stretched elastomeric strands 14 sandwiched between the first and second substrates 16, 18.

After passing through nip 29, the machine direction tension is maintained on preform web 2 as it moves downstream. The tensioned or stretched preform web 2 is schematically illustrated in FIG. 5. As it continues to move downstream the stretched preform web 2 is heated in line. In line heating is accomplished by substantially simultaneously applying heat to one or both sides of substrates 16, 18 of the preform web 2 by contacting the preform web 2 with one or more heated rolls. In the preferred method, there are one or more (three are shown in FIG. 2) heated rolls 42, 44, 46, and the relatively flat surface of preform web 2 contacts the relatively flat outer surface of each of the heated rolls 42, 44, 46 in a serpentine path such that heat is applied to only one side of web 2, as illustrated best in FIG. 2. Thus, at the preferred line speed of about 300 feet per minute, heated rolls 42, 44, 46 contact the outer surface of substrate 18 to thereby heat that side of preform web 2 to provide uniform heat transfer to the entire web 2. However, a multiple series of in-line rolls could also be used if desired. Typically, rolls 42, 44 and 46 are filled with hot oil at a temperature range of from about 250° F. to about 300° F. which will heat the preform web 2 to a temperature range of about 200° F. to about 250° F. before exiting the surface of roll 46. Although three heated rolls are illustrated in FIG. 2, it is clear that any number of heated rolls can be employed depending upon the time and temperature desired for heating.

After being heated, preform web 2 moves downstream from heated rolls 42, 44 and 46 and is allowed to cool. As it cools, preform web 2 is also allowed to contract and relax in the machine direction to form gathered web 8. The machine direction tension is released after rolls 42, 44 and 46 due to reduction in the line speed which permits the elastomeric strands 14 to contract and cause a reduction in length of the preform web 2 due to the gathering of the layers in an accordion fashion to form the gathered preform web 8. The gathered preform web 8 is schematically illustrated best in FIG. 4. This contraction process is schematically illustrated in FIG. 3.

After web 8 is cooled and gathered to the desired degree, web 8 is fed to a nip 48 formed between nip rolls 50, 52. At substantially the same time, a release liner or sheet 54 is delivered from supply roll 56 and fed at a predetermined speed equal to the line speed of gathered web 8 towards nip 48. A pressure sensitive adhesive layer 6, such as a butyl adhesive, is applied onto release liner 54 using adhesive applicator 58. Examples of suitable applicators are spray and slot coaters, preferably a slot coater. It should be noted that adhesive layer 6 could also be applied onto gathered web 8, specifically the outer surface of substrate 18, if desired. However, it will typically be more convenient to apply adhesive layer 6 directly onto release liner 54.

Release liner 54 and gathered web 8 together with adhesive layer 6 are brought into contact with each other at nip 48 formed by counter rotating nip rolls 50, 52. Gathered web 8 and release liner 54 are forced together by compression into direct contact with the adhesive layer 6 in the nip 48 to form the elastic laminate 10. Thereafter, laminate 10 is fed to a rewinder schematically illustrated as 64 in FIG. 2 so that laminate 10 can be stored in roll form. The elastic laminate 10 is schematically illustrated in FIG. 1A as an end view with the gathers of laminate 10 represented by the number 12.

It is important, when the tension on the elastomeric strands 14 is released to form gathered preform web 8, that the hot melt adhesive has formed a strong adhesive bond between the first and second substrates 16, 18 and the elastomeric array of strands 14. Thus, it is important that the hot melt adhesive has high initial tack to quickly provide a strong bond between the strands 14 and the substrates 16, 18. Preferably, it is also desirable that the adhesive have good elevated temperature creep resistance to adequately bond the strands 14 in place. Preferred examples include thermoplastic hot melt pressure sensitive adhesives having a polymer selected from the group consisting of styrene-iosprene-styrene (SIS); styrene-butadene-styrene (SBS); styrene-ethylene-butylene-styrene (SEBS); ethylene-vinyl acetate (EVA); amorphous poly-alpha-olefin (APAO); and ethylene-styrene interpolymer (ESI). Blends of pressure sensitive adhesives may also be used if desired. Most preferred are adhesives based on styrene-isoprene-styrene (SIS) block copolymers. The preferred hot melt pressure sensitive adhesive is an SIS based product available under Product No. H2385 from Bostik, Inc.

The hot melt adhesive is preferably selected such that it provides good bond strength between the layers and also has good ultraviolet light and thermal stability. A combination of hot melt adhesive compositions can be used by feeding to separate orifices from different reservoirs. For example, a first hot melt adhesive which provides high initial tack such as styrene-isoprene-styrene hot melt adhesives like those known in the art for use in diaper manufacture can be applied, followed by another hot melt adhesive supplied from a separate orifice, which provides other desirable attributes such as increased flexibility which might also be desirable for outdoor applications such as flashing.

In addition to the hot melt pressure sensitive adhesive referred to above, the process of the present invention utilizes a curable adhesive to provide long term strength and durability to elastic laminate 10. In applications such as window flashing, the elastic laminate 10 will be subjected to a wide range of temperature extremes due to summer and winter temperatures as well as sunlight which requires the lamination to have excellent long term aging, i.e. UV stability, characteristics. As noted above, although the hot melt pressure sensitive adhesive provides excellent “green” strength to hold the lamination together initially during fabrication, such hot melt adhesives do not provide adequate long term strength, temperature resistance and durability. Accordingly, curable adhesives, such as single component adhesives that are heat curable, ultra-violet light curable (UV curable), or moisture curable, or dual component adhesives that are crosslinkable may be used. The preferred curable adhesive is polyurethane based, and most preferably is an aliphatic moisture cure polyurethane available under the designation XPU18228 from Bostik, Inc. Other examples include two component polyurethane and two component epoxy adhesives. When a moisture curable adhesive is used, at least one of the substrates should be moisture permeable. The curable adhesive is applied directly to substrate 16 using slot applicator 28 and/or to substrate 18 using slot applicator 34. The hot melt pressure sensitive adhesive is then melt blown or sprayed onto the elastic strands 14 prior to entering nip 29. The curable adhesive may be applied in a range of add on levels of about 2 to about 20 grams per square meter, but preferably is applied at an add on level of about 6 grams per square meter. Likewise, the pressure sensitive hot melt adhesive may be applied in a range of add on levels of about 2 to about 20 grams per square meter, but is preferably melt blown or sprayed onto strands 14 at an add on level of about 15 grams per square meter. The preferred hot melt pressure sensitive adhesive is an SIS based product available under Product No. H2385 from Bostik, Inc.

FIG. 2A illustrates an alternate embodiment of the process for making elastic laminate 10. All of the apparatus and process steps illustrated in FIG. 2A are identical to that described herein with respect to FIG. 2 except the heating step. Accordingly, like apparatus is designated with the letter “A.” With regard to the heating step, FIG. 2A illustrates that both sides of preform web 2A can be heated rather than merely one side as illustrated in FIG. 2. One way to accomplish heating both substrates 16A and 18A is to contact preform web 2A with the outer surfaces of a plurality of heated rolls 66, 68 and 70 in a serpentine path as illustrated in FIG. 2A. Thus, one substrate 18A contacts roll 66 while substrate 16A next contacts roll 68, and so on, until preform web 2A is heated to the desired temperature. Although three heated rolls are illustrated in FIG. 2A, it is clear that any number of heated rolls can be employed depending upon the time and temperature desired for heating.

FIG. 2B illustrates another alternate embodiment of the process for making elastic laminate 10. All of the apparatus and process steps illustrated in FIG. 2B are identical to that described herein with respect to FIG. 2A except the process illustrated in FIG. 2A is continuous whereas the process illustrated in FIG. 2B is discontinuous. Accordingly, like apparatus is designated with letter “B.” With regard to the discontinuous nature of this alternate process, FIG. 2B illustrates that instead of immediately being laminated with a pressure sensitive adhesive, such as a butyl adhesive, and a release liner, the gathered elastomeric web 8B may instead be fed to a J-box 72 and then to a festooner 74 for storage. J-box 72 functions as an accumulator and also allows gathered web 8B to further cool and relax. From J-box 72, gathered web 8B is then fed to festooner 74 where gathered web 8B is packaged by being directed in a back and forth motion to form layers in a container where gathered web 8B will even further cool and relax.

It should be noted that although FIG. 2B illustrates single side heating of preform web 2B by rolls 42B, 44B and 46B, the dual side heating arrangement of FIG. 2A could also be employed. Also, one skilled in this art will readily recognize that FIGS. 2, 2A and 2B are schematic drawings only, and that the distances between components in FIGS. 2, 2A and 2B are for illustration purposes only, as are the sizes thereof.

Once gathered web 8 is packaged by festooner 74, it may be shipped off-site or stored for later use. In any event, elastic laminate 10 may later be formed by applying the pressure sensitive adhesive and release liner thereto. This can be accomplished at any desired location as well as by any appropriate process, such as via the process illustrated and described with respect to FIG. 2 or 2A.

### EXAMPLE ONE

This example demonstrates formation of an elastic laminate comprising as one component thereof a gathered elastomeric web having a first substrate of an embossed and creped flash-spun non-woven high density polyethylene, a second substrate comprising a linear low density polyethylene film, and an array of Lycra® XA spandex elastic yarns sandwiched between the two layers with the substrates being bonded using a combination of two adhesives, one a thermoplastic hot melt and the other a moisture curable polyurethane adhesive. The gathered web was prepared in accordance with the process of FIG. 2 and was covered on one side with a butyl adhesive and a release liner made of siliconized paper.

The substrates were laminated at a lamination speed of 300 ft/min with an array of 48 strands of Lycra® XA spandex having a linear density of 620 decitex per filament. The embossed side of the first substrate was adjacent the spandex array. The individual spandex strands were equally spaced with a spacing between the outermost strands of 7.625 inches (19.4 cm). The Lycra® XA spandex array was tensioned to an elongation of 280% during the lamination. H-2385 styrene-isoprene-styrene (SIS) hot melt adhesive from Bostik, Inc. was applied directly onto substrate 16 using a DF2 spray head from Nordson Corporation of Westlake, Ohio with an air temperature of 390° F. and air pressure of 10 psi in the metering head, and XPU 18288 polyurethane curable adhesive, also available from Bostik, Inc. which was applied using a slot die applicator directly onto substrate 18 having a width of 8.5 inches (21.6 cm). The styrene-isoprene-styrene (H-2385) hot melt adhesive was held in a tank at 380° F. and applied at an add-on of 15 g/m² and the polyurethane adhesive (XPU 18288) was held in a tank at 250° F. and applied at an add-on of 6 g/m². The open time (time between the point at which the hot melt is sprayed onto the substrate 16 and the point at which the Tyvek® sheet, Lycra® XA spandex, SIS hot melt, polyurethane and polyethylene film meet in the nip rolls) was 0.43 seconds (corresponding to a distance of 13 inches (33 cm). The nip roll pressure was set at 40 psi. A slitter was located at the end of the process having a width of 8 inches (20.3 cm).

The heated rolls 42, 44 and 46 were filled with hot oil at a temperature of 275° F., and the dwell time about the heated rolls was about 0.8 seconds. A butyl adhesive previously designated as 1183 and available from Bostik, Inc. was applied directly onto the release liner 54 at an add-on level of 0.020 inches.

It was determined that a selected sample of the heated and cooled gathered elastomeric web 8 formed via the process of FIG. 2 had contracted to about 6 inches from an initial stretched state of about 18 inches. The selected sample was also devoid of any machine direction skewing and/or any stove-piping. In contrast, a sample which was not heated via the process of FIG. 2 had only contracted to about 10 inches from its initial stretched state of about 18 inches.

We claim:

1. A method of controlling dimensional contraction of an elastomeric web, comprising the steps of:
feeding a stretched elastomeric web in a machine direction;
heating said stretched elastomeric web by contacting at least one side of said stretched elastomeric web with at least one heated roll; and
allowing said stretched elastomeric web to contract in the machine direction while said elastomeric web cools and moves downstream of said at least one heated roll to form a gathered elastomeric web.

2. The method of claim 1 wherein said elastomeric web cools by being exposed to air.

3. The method of claim 2 wherein the air is at ambient temperature.

4. The method of claim 1 wherein the step of heating comprises applying heat to opposite sides of said stretched elastomeric web.

5. The method of claim 4 wherein the opposite sides of said stretched elastomeric web are heated substantially simultaneously.

6. The method of claim 4 wherein heat is applied by contacting each of said opposite sides of said stretched elastomeric web with one or more heated rolls.

7. The method of claim 6 wherein said stretched elastomeric web contacts said heated rolls in a serpentine path.

8. The method of claim 1 wherein the step of allowing said stretched elastomeric web to contract comprises reducing machine direction line speed of said web.

9. A method of making an elastic laminate, comprising the steps of:
feeding a stretched elastomeric web in a machine direction;
heating said stretched elastomeric web by contacting at least one side of said stretched elastomeric web with at least one heated roll;
allowing said stretched elastomeric web to contract in the machine direction while said elastomeric web cools and moves downstream of said at least one heated roll to form a gathered elastomeric web;
feeding a release liner in said machine direction;
applying a pressure sensitive adhesive to one side of either said gathered elastomeric web or said release liner; and
compressing said gathered elastomeric web and said release liner together to form an elastic laminate.

10. The method of claim 9 wherein said pressure sensitive adhesive comprises a synthetic rubber adhesive.

11. The method of claim 10 wherein said synthetic rubber adhesive is selected from the group consisting of a butyl adhesive, a polyisobutylene adhesive, an isobutylene copolymer adhesive and a styrenic block copolymer based hot melt adhesive.

12. The method of claim 11 wherein said butyl adhesive contains a butyl polymer which is selected from the group consisting of butyl, bromobutyl, chlorobutyl, star-branched butyl and star-branched halobutyl.

13. The method of claim 9 wherein the step of heating comprises applying heat to opposite sides of said stretched elastomeric web.

14. The method of claim 13 wherein the opposite sides of said stretched elastomeric web are heated substantially simultaneously.

15. The method of claim 13 wherein heat is applied by contacting each of said opposite sides of said stretched elastomeric web with one or more heated rolls.

16. The method of claim 15 wherein said stretched elastomeric web contacts said heated rolls in a serpentine path.

17. The method of claim 9 wherein said release liner comprises a sheet of siliconized paper.

18. A method of making an elastic laminate, comprising the steps of:
feeding a first substrate in a machine direction;
feeding a second substrate aligned with said first substrate in said machine direction;
feeding an array of elastomeric strand material between said first and second substrates, said elastomeric strand material being stretched in said machine direction and aligned with said first and second substrates;
applying a curable adhesive to one of said substrates;
applying a thermoplastic hot melt adhesive to one of said substrates;
compressing said first and second substrates, said curable adhesive, said hot melt adhesive and said elastomeric strand material together to form an elastomeric preform web while maintaining said elastomeric strand material in its stretched state;
heating the stretched elastomeric preform web by contacting at least one side of said stretched elastomeric preform web with at least one heated roll;
releasing machine direction tension on said elastomeric strand material to permit said stretched elastomeric preform web to contract in the machine direction and form a gathered elastomeric web;
cooling the gathered elastomeric web while said gathered elastomeric web moves downstream of said at least one heated roll;
feeding a release liner in said machine direction;
applying a pressure sensitive adhesive to one side of either said gathered elastomeric web or said release liner; and
compressing said gathered elastomeric web and said release liner together to form an elastic laminate.

19. The method of claim 18 wherein said hot melt adhesive is a pressure sensitive hot melt adhesive which includes a polymer selected from the group consisting of styrene-isoprene-styrene (SIS); styrene-butadiene-styrene (SBS);
styrene-ethylene-butylene-styrene (SEBS); ethylene-vinyl acetate (EVA);
amorphous poly-alpha-olefin (APAO); and ethylene-styrene interpolymer (ESI).

20. The method of claim 18 wherein said hot melt adhesive is a styrene-isoprene-styrene based adhesive.

21. The method of claim 18 wherein said curable adhesive is selected from the group consisting of single-component and dual-component curable adhesives.

22. The method of claim 18 wherein said curable adhesive is a polyurethane-based adhesive.

23. The method of claim 18 wherein said first substrate is a high density polyethylene sheet.

24. The method of claim 18 wherein said second substrate is a polyolefin film.

25. The method of claim 24 wherein said second substrate is a low density polyethylene film.

26. The method of claim 18 wherein said pressure sensitive hot melt adhesive is applied at an add-on level of from about 2 to about 20 grams per square meter.

27. The method of claim 26 wherein said pressure sensitive hot melt adhesive is applied at an add-on level of about 15 grams per square meter.

28. The method of claim 18 wherein said curable adhesive is applied at an add-on level of about 2 to about 20 grams per square meter.

29. The method of claim 28 wherein said curable adhesive is applied at an add-on level of about 6 grams per square meter.

30. The method of claim 21 wherein said curable adhesive is selected from the group consisting of heat curable, ultra-violet light curable and moisture curable single component curable adhesives.

31. The method of claim 21 wherein said curable adhesive is a moisture curable polyurethane.

32. The method of claim 18 wherein said curable adhesive and said thermoplastic hot melt adhesive are both applied to the same substrate.

33. The method of claim 18 wherein said curable adhesive and said thermoplastic hot melt adhesive are applied to different substrates.

34. The method of claim 18 wherein said curable adhesive is applied to said first substrate, and said thermoplastic hot melt adhesive is applied simultaneously to said elastomeric strand material and said second substrate.

35. The method of claim 18 wherein said curable adhesive is applied continuously.

36. The method of claim 18 wherein said curable adhesive is applied discontinuously.

37. The method of claim 18 wherein said hot melt adhesive is applied continuously.

38. The method of claim 18 wherein said hot melt adhesive is applied discontinuously.

39. The method of claim 18 wherein said pressure sensitive adhesive comprises a synthetic rubber adhesive.

40. The method of claim 39 wherein said synthetic rubber adhesive is selected from the group consisting of a butyl adhesive, a polyisobutylene adhesive, and isobutylene copolymer adhesive.

41. The method of claim 40 wherein said butyl adhesive contains a butyl polymer which is selected from the group consisting of butyl, bromobutyl, chlorobutyl, star-branched butyl and star-branched halobutyl.

42. The method of claim 18 wherein the step of heating comprises applying heat to opposite sides of said stretched elastomeric preform web.

43. The method of claim 42 wherein the opposite sides of said stretched elastomeric preform web are heated substantially simultaneously.

44. The method of claim 42 wherein heat is applied by contacting each of said opposite sides of said stretched elastomeric preform web with one or more heated rolls.

45. The method of claim 44 wherein said stretched elastomeric preform web contacts said heated rolls in a serpentine path.

46. The method of claim 18 wherein said release liner comprises a sheet of siliconized paper.
